(19) United States
(12) Patent Application Publication
(10) Pub. No.: US 2010/0311032 A1
(43) Pub. Date: Dec. 9, 2010

(54) SYSTEM AND METHOD FOR GENERATING FLASH-BASED EDUCATIONAL TRAINING

(75) Inventors: Timothy R. Samoff, Kansas City, MO (US); Mickey H. DeHook, Olathe, KS (US); Michael L. Diehl, Lee's Summit, MO (US); Tyson Hofsommer, Gardner, KS (US); Andrew C. Fletcher, Gilbert, AZ (US)

Correspondence Address: SNR DENTON US LLP, P.O. BOX 061080, CHICAGO, IL, 60606-1080, US

(73) Assignee: Embarg Holdings Company, LLC

(21) Appl. No.: 12/480,466

(22) Filed: Jun. 8, 2009

(51) Int. Cl. G09B 7/00

(52) U.S. Cl. 434/353

(57) ABSTRACT

A system and method for generating a Flash-based educational training course, wherein course content may be received from a user generating the training course. The course content may be parsed into segments. An XML file may be generated from the parsed course content. An XML instance may be created. A function that includes actions to be performed by the XML instance, once the XML file has been read, may be initialized. The function may be assigned to the onLoad property of the XML instance, causing the function to be performed upon the completion of the data loading. The XML load may be started using a Flash module. The course content may be presented using the Flash module.

### BACKGROUND OF THE INVENTION

There is often a need for orientation and other training when new employees are integrated into a company or similar institutions. One way to provide training is by using live instructors in a formal classroom setting. Recently, computer based training has become more common and is often just as effective as, if not more than, a live presentation. In addition to new-hire orientation classes, companies often need to provide training in order to maintain certain certifications or integrate new products or technology. By providing computer based training, courses can be distributed to employees to be taken when there is down time, allowing for more productive use of their employees' time.

### BRIEF SUMMARY OF THE INVENTION

In one embodiment of the present invention, by providing a computerized tool for creating educational training, users with little understanding of the underlying process can create Flash-based educational training, in a standardized style, which is readily controlled, as well as evaluated for quality and accuracy before being entered into service.

In one embodiment of the present invention, a system and method may be provided for generating a Flash-based educational training course. Course content may be received from a user generating the training course. The course content may be parsed into segments. An XML file may be generated from the parsed course content. An XML instance may be created. A function that includes actions to be performed by the XML instance, once the XML file has been read, may be initialized. The function may be assigned to the onLoad property of the XML instance, causing the function to be performed upon the completion of the data loading. The XML load may be started using a Flash module. The course content may be presented using the Flash module.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of one embodiment of an environment operable to generate Flash-based educational training and content management, consistent with the present invention;

FIG. 2 is a block diagram depicting components of one embodiment of a training course server operable to provide for creating, storage, and management of Flash-based training courses;

FIG. 3 is one embodiment of a flow diagram for creating, approving, storing, and managing content, consistent with the present invention;

FIG. 4A depicts an illustration of one embodiment of a new course request screen, consistent with the present invention;

FIG. 4B depicts an illustration of one embodiment of a released projects screen, consistent with the present invention;

FIG. 4C depicts an illustration of one embodiment of a project module listing screen, consistent with the present invention;

FIG. 4D depicts an illustration of one embodiment of an module editing screen, consistent with the present invention;

FIG. 4E depicts an illustration of one embodiment of a student interface screen, consistent with the present invention;

FIG. 5 is a block diagram of one embodiment of modules configured to create, manage, store, and approve Flash-based courses, consistent with the present invention; and

FIG. 6 is a flowchart of one embodiment of a method for generating Flash-based educational training courses.

### DETAILED DESCRIPTION OF THE INVENTION

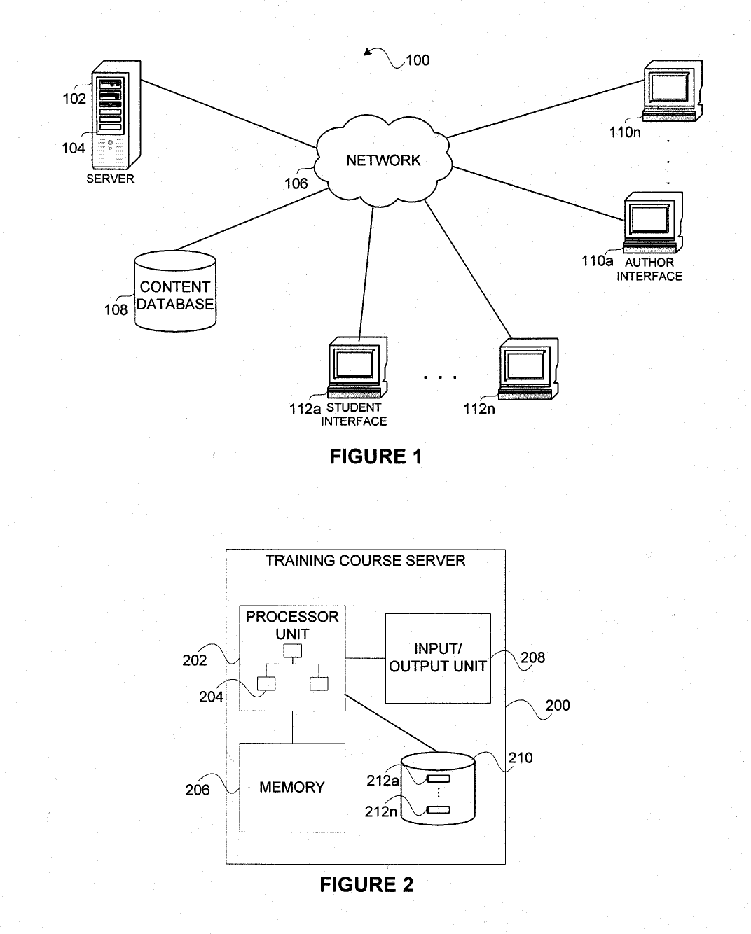

FIG. 1 is an illustration of one embodiment of an environment 100 operable to generate Flash-based educational training and content management, consistent with the present invention. In this embodiment, a training course server 102 may be provided, which includes software modules 104. The training course server 102 may be in communication with a content database 108 over a communications network 106. Additionally, author interface devices 110a-110n (collectively 110) may also be in communication with the training course server 102 via the communications network 106. Separate student interface devices 112a-112n (collectively 112) may additionally be provided to allow students to access content located on the training course server 102 via the communications network 106.

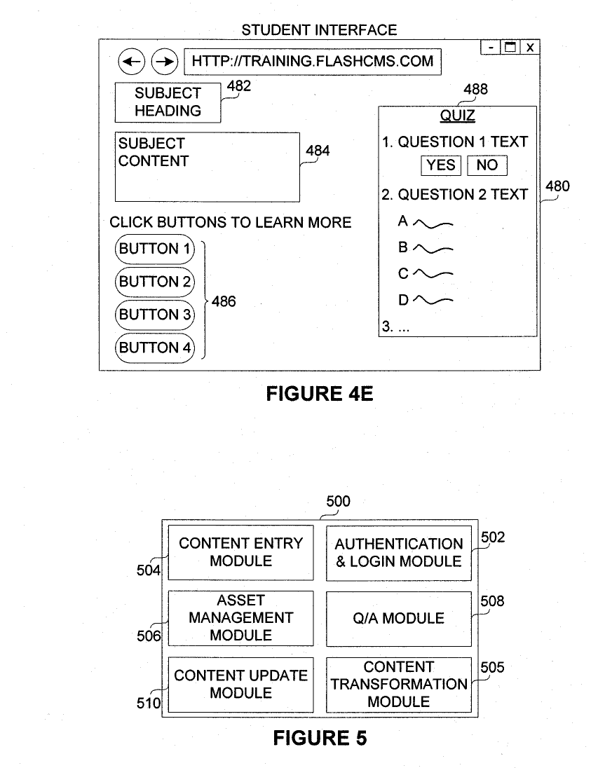

The training course server 102, author interface devices 110, and student interface devices 112, may be combined into as few as one computing device, or may comprise many separate devices depending upon the particular setup of the network, as well as other factors. The training course server 102 may be any computing device configured to execute modules, such as software modules 104 located within the training course server 102, or located remotely, but in communications with the training course server 102. The software modules 104 allow the training course server 102 to provide Flash-based educational training courses, as well as other principles of the present invention, and will be described below in greater detail in regard to FIG. 5.

The communications network 106 may be the Internet, a LAN, a WAN, a cellular based network, WiMAX, or any other wired or wireless communications network operable to communicate between the training course server 102 and the other devices. The content database 108 may be any storage device operable to store software modules, user data, or other data used by the training course server 102. The content database 108 may be located in communication with the communications network 106 or may be located within the training course server 102 itself. In an alternative embodiment, the training course server includes sufficient storage, and no content database 108 is separately provided.

The author interface device 110 may be any computing device operable to allow a user to communicate with the training course server 102 and create, modify, or otherwise update training courses that are located within the training course server 102, the content database 108, or in any other storage device. The author interface device 110 may be a device which solely interfaces with the training course server 102, may be an ordinary computing device such as a PC or Mac, or any other computing device that is operable to interface with the training course server 102. There may be only one author interface device 110 or there may be multiple interface devices 110 that may simultaneously access the training course server 102. In one embodiment, the author interface device 110 additionally includes templates, which may be preformatted or edited as needs arise.

The student interface device 112 may additionally be any computing device operable to communicate with the training course server 102. In one embodiment, the student interface device 112 is a personal computer running a web browser and configured to communicate over communications network 106 with the training course server 102. In this embodiment, a student (not shown) may access training courses using the student interface 112 by inserting a web address into the web browser, which accesses the training course server 102.

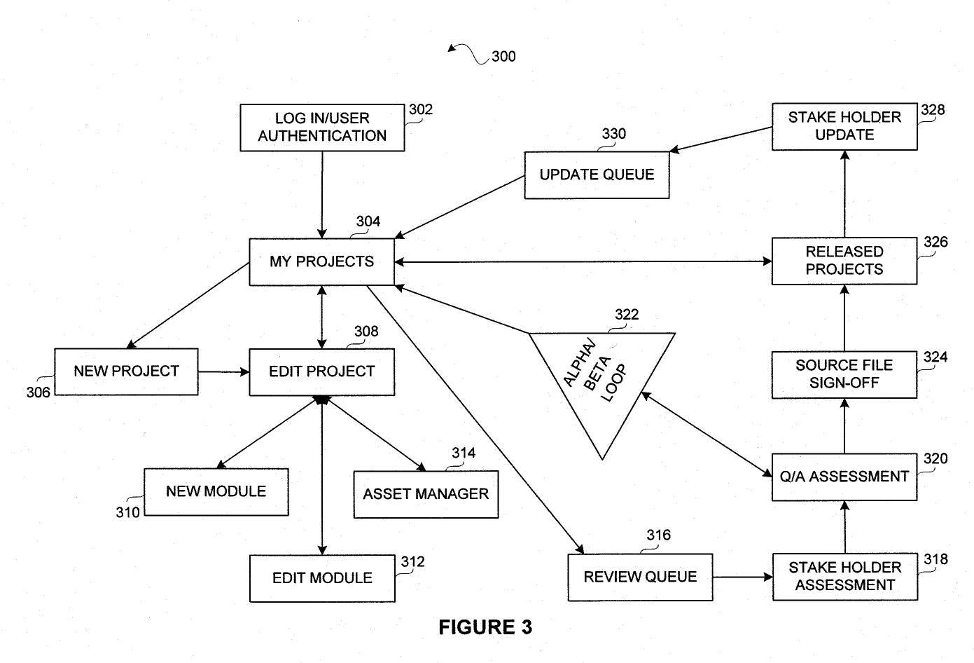

FIG. 2 is a block diagram depicting components of one embodiment of a training course server 200 operable to provide for creating, storage, and management of Flash-based training courses. The training course server 200 may include a processing unit 202 for processing data and accessing memory 206 or other database tables containing information regarding the Flash-based training courses. The processing unit 202 may execute software 204 operable to perform functionality of the training course server 200, including generating courses, managing course files and other related functionality described below in greater detail. Software modules that operate in the software 204 are described below in more detail in reference to FIG. 5. Memory 206 may also be located within the training course server 200 for storing data being processed by the processing unit 202. The training course server 200 may include an input/output (I/O) unit 208 for receiving and communicating data between remote computing devices, such as the author interface and student interface over a communications network. A data storage unit 210 may be included in, or be in communication with, the training course server 200. The data storage unit 210 may be a hard drive or any other type of volatile or non-volatile memory capable of storing data. Within the data storage unit 210 may be one or more data repositories 212a-212n (212), such as a database or multiple databases, capable of storing and organizing data. Some example data may include XML files, Flash-based courses, and user priority information, but any information may be stored within the data repositories 212. In one embodiment, rather than including the data storage unit 210, the switch 200 may use a memory 206 that is large enough to store any necessary data.

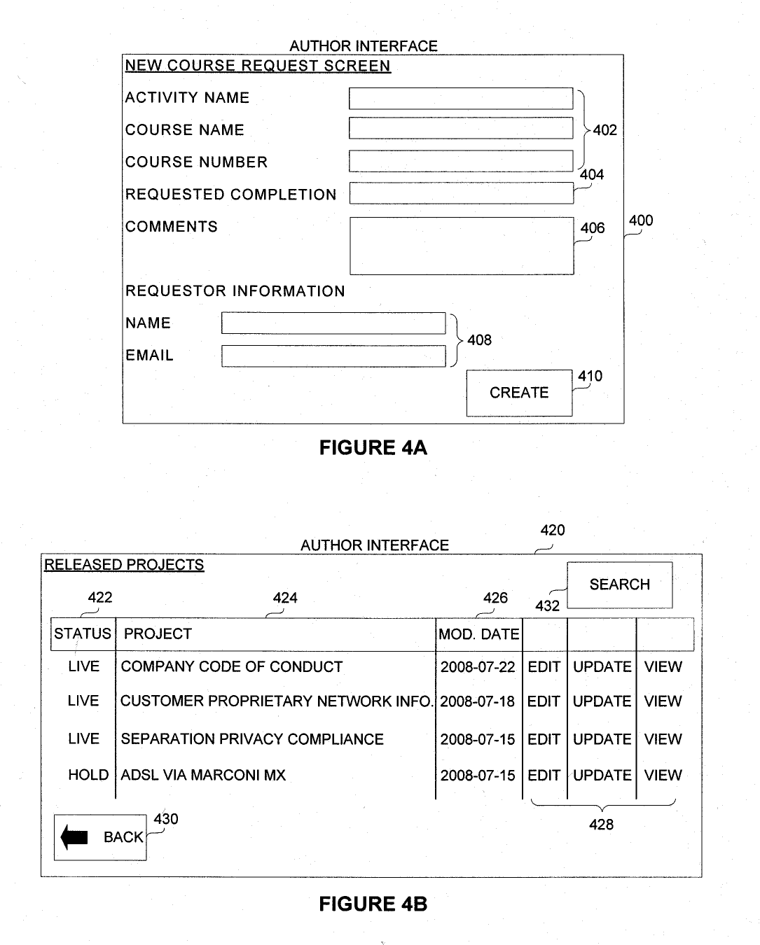

FIG. 3 is one embodiment of a flow diagram 300 for creating, approving, storing, and managing content. In one embodiment, a login module 302 is provided to assist in user authentication, and access control, and to determine privileges for a particular user. From the login module 302, a projects menu module 304 may be accessed. In one embodiment, the projects menu module 304 may serve as a “main menu” for choosing various options available within the training course server 102. From the projects menu module 304, a user may select the new project module 306, which may allow the user to create a new project, such as a new course or any other type of project. In another embodiment, from the projects menu module 304, a user may alternatively select an edit project module 308, which allows a user to select an already created project and update or modify content within the project.

In one embodiment, after the new project module 306 is selected, the new project module 306 may call the edit project module 308 to allow the user who just created the new project to edit content within the project. The edit project module 308 may additionally call the new module module 310, which allows a new module to be inserted within the project being edited at the time. In one embodiment, an edit module module 312 may be called by the edit project module 308 to allow a user to edit content within a particular module, such as course questions, course descriptions, materials presented, or any other content within the module.

An asset manager module 314 may additionally be called by the edit project module 308 to ensure that content within the training course server 102 or content database 108 is managed properly. For example, in one embodiment, when a user selects the edit module module 312, the asset manager module 314 may be called in response, to locate and access the module prior to being able to edit the particular module. The asset manager module 314 may query the content database 108 or other storage within the training course server 102, to determine whether or not the module exists and/or lock the particular module so that only one person may be editing a module at a time. The asset manager module 314 may provide other suitable functionality, such as the functionality provided by modern document management systems.

In one embodiment, after creating a project using the new project module 306, editing a project using the edit project module 308 or creating or editing a module using new module module 310 or edit module module 312 respectively, a review queue module 316 may be used to list the particular projects or modules that are needed to be reviewed. In one embodiment, another function of the review queue module 316 is to alert a stakeholder or other quality assurance person that a module or project under their care has been updated and needs to be reviewed. Without any other further author interaction, a signal to the stakeholder or quality assurance person may be automatically sent.

A stakeholder assessment module 318 may be accessed by a stakeholder upon receiving notification that there is material for the stakeholder to review or at any other time in which the stakeholder wishes to review material that he or she is authorized to review. A stakeholder may be a manager of the author, an expert in the subject matter, or any other person who has a stake in assuring that the content located within the project or module is correct. Upon stakeholder approval, a Q/A assessment module 320 may be accessed, allowing a member of a quality assurance team to review the newly added or modified content. In one embodiment, an alpha/beta loop module 322 may be accessed, ensuring that a second set of eyes is required to review the new or modified module or project before getting final approval. The alpha/beta loop module 322, in one embodiment, may then place the content back into the review queue using the review queue module 316 where the stakeholder assessment and Q/A assessment is performed again. This may allow for any comments made by the stakeholder or Q/A to be addressed and reviewed before final approval is given.

A source file sign off module 324 may be provided to allow a programmer or other person with knowledge of the source file contents, to approve the source file before releasing the project or module for public use. Upon approval of the source file, a released projects module 326 may be called whereby the source file that has just been signed off is added to a list of released projects. Additionally, the projects menu module 304 may directly call the released projects module 326 in order to derive a list of released projects that are available for users to access.

A stakeholder update module 328 may also be provided for allowing a stakeholder to update content within modules or projects under their control, to include updated information, or to correct errors. After the stakeholder update module 328 has been accessed, in one embodiment, the update queue module 330 may be called to place the updated content within an update queue to ensure that any changes made by the stakeholder will run through the review process and quality assurance process again before being released. In one embodiment, any released projects that get updated but are not through with being checked by Q/A, may have the original or previous version of that module or project available to be accessed until the new version is finally approved. In other embodiments, the previous version may no longer be available or may be locked, and an error message may be given that “the content is being updated” and to “try again later” or a similarly suitable message.

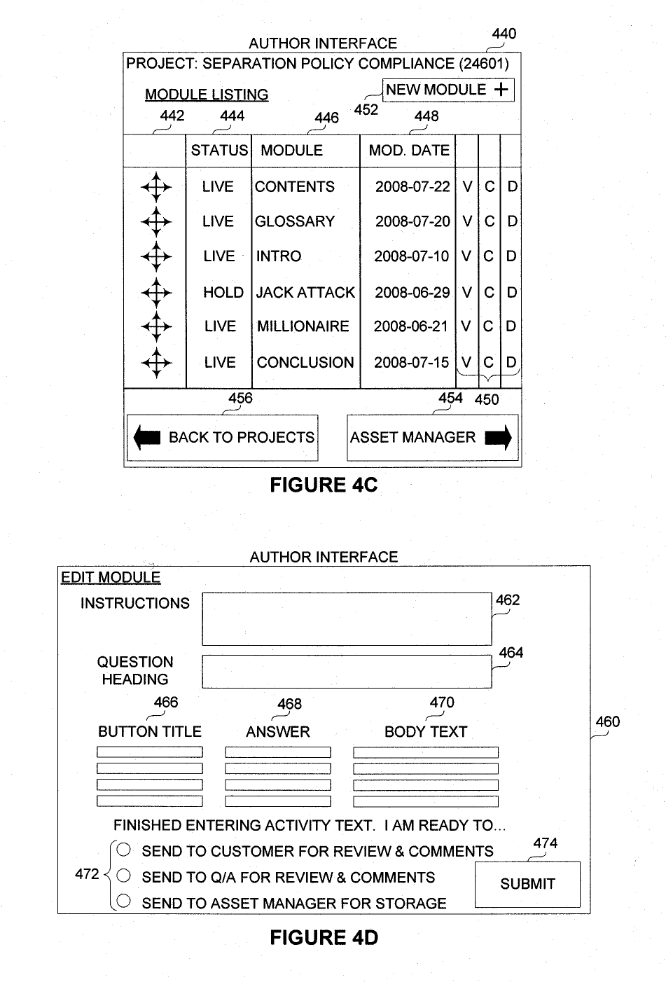

FIG. 4A depicts an illustration of one embodiment of a new course request screen 400 consistent with the present invention. In one embodiment, the new course request screen may include file identification fields 402 including, for example, activity name, course name, and course number. Other embodiments may include additional information regarding the course or activity. A requested completion date field 404 may additionally be included within the new course request screen 400. The requested completion date may be a date in which all activity for the course needs to be completed, including the time needed for quality assurance and other checks that are to take place before the course is released for public use.

A comments field 406 may also be provided in this embodiment. The comments field 406 may allow for a creator or requester filling in the new course request screen information to add comments viewable by anyone editing material or reviewing material within or related to the course. A requester information field 408 may additionally be provided to allow the person requesting the new course to be identified by anyone interested in the particular course. In one embodiment, a requester information field 408 includes a name and an e-mail address, but may also include a phone number or any other requester information that is desired to be stored. Upon completion of the new course request screen 400 fields, a person requesting the new course may select the create button 410 setting into place the request for the new course, and in one embodiment, initiating other modules related to creating the new course.

FIG. 4B depicts an illustration of one embodiment of a released projects screen 420 consistent with the present invention. In one embodiment, the released projects screen 420 includes a status field 422, a projects listing field 424, a modification date field 426 and action selection buttons 428. Additionally, in one embodiment, a search button 432 may be provided to allow a user to search through released projects for a particular entry in which they are interested in. Additionally, a back button 430 may be provided to allow a user the opportunity to not select any of the projects which are listed.

In one embodiment, the status field 422 provides the status of each project that is found in the projects listing field 424. Statuses may include “live” for projects which have been completed, “reviewed,” and “hold” for projects which are either currently being modified, not reviewed, or for another reason, placed on hold. The projects listing field 424 lists the name of each project that has been released allowing the user to select a particular project that they are looking for. The modification date field 426 allows the user to determine the last time a particular project has been modified or otherwise released. The action selection buttons 428 allows the user, in one embodiment, to select whether they want to edit a released project, update the released project, or view the released project. In alternative embodiments, the action selection buttons may be different, but any action that is available for the particular released project can be displayed within this field.

If a user chooses not to select any of the projects, the user may select the back button 430 to return to the previous menu. Additionally, if a user knows a particular projects name or other information, the search button 432 may be selected to allow a user to enter in search criteria and have the released projects searched for a match.

FIG. 4C depicts an illustration of one embodiment of a project module listing screen 440 consistent with the present invention. In one embodiment, the project module listing screen 440 includes a position change button 442, a status field 444, a module name field 446, a modification date field 448, and action selection buttons 450. A new module button 452 may also be provided to initiate the creation of new modules for the course being displayed on the project module listing screen 440.

The position change button 442 allows a user to move the particular module up or down in the listing allowing a user to edit the order in which the particular module is placed within the course or project. For example, if the glossary shown in the module name field 446 was determined to be best placed at the end, a user may select the position change button and move the glossary module further down the listing. Similar to FIG. 4B, the module name field 446 and status field 444 provide similar functionality. Likewise, the modification date field 448 and the action selection buttons 450 operate similar to the released projects screen, with the exception that these buttons are relating to the modules within the projects on this screen rather than the projects listing on FIG. 4B. If a user wishes to include an additional module within the particular project or course being displayed, the new module button 452 may be selected that will initiate the creation of a new module for insertion within the project or course being displayed. In one embodiment, another option may be provided to go directly to the asset manager by using an asset manager button 454. The asset manager button 454 will allow a user to directly access the asset manager or document control system containing the course and module content directly from the project module listing screen 440. If a user chooses to perform none of the actions allowed on the project module listing screen 440, the user may select the back to projects button 456 to return to the projects listings.

FIG. 4D depicts an illustration of one embodiment of a module editing screen 460 consistent with the present invention. In one embodiment, the module editing screen 460 includes an instructions field 462, a question heading field 464, a button title field 466, an answer field 468, body text field 470, user selection buttons 472 and a submit button 474. The module editing screen 460 may be used for editing one module that is within a course, which is either already existing, or just being created. One example of a module may include a quiz related to content that has been taught in this or another module. The instructions field 462 may provide instructions for the quiz to a user of the module.

A question for use within the quiz may go in the question heading field 464, or depending upon the type of quiz, the question heading field 464 may include a subject for the questions that will be placed later within the module. The button title field 466 in one embodiment may be a field that lists what is to be displayed on answer selection buttons to a user taking the quiz. The answer field 468 may contain either a selection for answers that a user may select from, or, in an alternative embodiment, each field in the answer field 468 column may include the correct answer for different questions. The body text field 470 may include the body of the question, or may include explanations related to the answer, which may be displayed to the user when they are executing the module.

After a user is through editing the module, the user may select one of the user selection buttons 472 to process the edited module. For example, in this embodiment, the editor may choose to send to a customer for review and comments, send to Q/A for review and comments, or send directly to the asset manager for storage. Upon making their selection, the user may click the submit button 474 to authorize the selection just selected to be performed. It is important to understand that any number of modules and module types may be included within a project, and therefore this is simply one embodiment with an example module.

FIG. 4E depicts an illustration of one embodiment of a student interface screen 480 consistent with the present invention. Upon approval of the module created in FIG. 4D, a screen such as the student interface screen 480 may then be displayed to a user running the course. In one embodiment, a subject heading field 482, a subject content field 484, a content selection field 486, and a quiz field 488 may be displayed to a user. In this embodiment, the module includes content on the left side of the screen and a quiz on the right side. The subject heading field 482 describes the subject of the content and the subject content field 484 actually displays the content. The content can be in text form, a video, audio, or any other format in which the student interface screen is operable to display. If a user chooses to learn more about the topic, the content selection field 486 contains buttons in which each button may link to an additional related topic or even an unrelated topic. In one embodiment, after reviewing the material on the left side, a user may choose to take the quiz located in the quiz field 488. In this embodiment, everything displayed on the student interface screen 480 has been entered in previously by a user and reviewed for quality and technical accuracy. The student interface screen 480 simply displays the content which has been entered previously and allows a user to execute the module. In one embodiment, between the creation of a module, such as the module created in FIG. 4D, and displaying the module, such as the student interface screen 480 in FIG. 4E, is transforming the module for use by Flash-based applications. Transforming a series of fields on an editing screen into a Flash-based training course will be described below in greater detail in reference to FIG. 5.

FIG. 5 is a block diagram of one embodiment of modules 500 configured to create, manage, store, and approve Flash-based courses, consistent with the present invention. In one embodiment, an authentication and login module may be provided for access control and permissions identification. For example, in one embodiment, permissions may determine what access rights a particular user has. For example, a user may be a “developer” that provides access to develop new modules or courses and may be considered an administration level privilege. Another user may be an “editor,” such as someone who utilizes the tool to create courses. Editor rights would give the user access to a personal work space in which they can create and edit various courses. In one embodiment, a “master editor” is another permission level, above the editor permission, that in addition to creating tasks, the master editor may also be allowed to delete projects or otherwise manage projects being edited by other users.

Another permissions level which may be assigned by the authentication and login module 502 is that of “supervisor.” A supervisor level permission may be assigned to a user who is not responsible for creating course content or approving any of the processes, but may allow the user access to the system to view various reporting statistics including quality assessment, competency, or other assessments of the projects within the content database. Another permissions level is that of “project reviewer.” A project reviewer permission level may be granted to persons in charge of the Q/A process whereby they can go in and review projects already in progress or completed and give feedback and/or approval or disapproval of the various projects.

Other embodiments may include fewer or more of these permission levels and still be considered within the scope of the present invention. A “stakeholder” permission level, for example, may additionally be included to allow a customer or other stakeholder responsible for requesting a project to be able to review and approve the project before the project is released for public use.

A content entry module 504 may be provided for initiating an editor that allows a user to enter in content into an existing or new module or course. The content entry module 504 may be called by the content update module 510, described below, or called by another process which is tasked with creating new content such as a course module. The content entry module 504 may allow the user entering the content to choose from preformatted templates, or a free-form entry if no preformatted template is applicable. In general, however, one advantage of preformatted templates is that it is easier for the user to create effective modules as well as to remain in a standardized format for modules within an organization.

In one embodiment, the content entry module 504 uses quiz templates. Quiz templates are set up to let a user or editor easily build multipart courses that use Macromedia Flash-based learning interactions (“Flash interaction”). A Flash interaction is a part of a movie in which a user interacts with the movie to provide a response. The Flash interactions may include one-off activities, quizzes, and learning aids that can either be placed into single course pages or assembled into complete Flash-based solutions (i.e. where all of the course content is delivered via a Flash-based user interface rather than in HTML-based web pages.)

In one embodiment, if the editor wishes to create a module containing a multiple choice quiz or other learning modules, a table of contents is first automatically generated. As an editor rearranges the course content, the table of contents will change as well. A template for requesting information needed by a Flash interaction to create a multiple choice quiz may contain a question field followed by answer fields for a user to choose from. This template may be presented to the editor to enter content into the module. As the user enters content, an XML file is generated that not only holds the layout of the project as a whole, but the structure of how the project is assembled. It is this XML file that is used for displaying course content to users, using the Flash interactions.

The generated XML file from the content entry module 504 is specifically structured with the data fields and layout formats. It is then added to the content database. When a user views the Flash interaction, the generated XML file is re-called from the content database, and the interaction's template file is combined with the XML file to re-create a customized interaction. The customized interaction then instructs the content transformation module 505 how to generate the HTML for viewing.

In one embodiment, another function of the content entry module 504 may include the ability to search stored documents to find particular words or phrases and replace the words with new text, also referred to as “find and replace.” Find and replace may be particularly useful when dealing with an error that is found when testing a module, so that the error may be located and corrected. The content entry module 504 may provide find-and-replace technology for existing or stored XML files, as well as prepared Flash interactions. Additionally, in one embodiment, stored XML files may be located and reused for future modules. By revising stored XML files, time may be saved during the creation of the module and the ability to edit the XML file and reuse parts of stored files also saves time during module creation.

In one embodiment, an asset management module 506 may be provided for managing the content of all of the courses and modules and providing a document management system to ensure that documents are properly reviewed and saved upon approval. In one embodiment, the asset management module includes a location where a user can upload files into a project directory structure that was created when the project was initiated. When the user adds an asset, the resulting on-screen information will provide the user with a URL that points to the location of the uploaded file. These URLs can be copied and used within any of the project modules that accept associated files. Many different types of files can be uploaded to the asset manager such as PDFs, word documents, images, audio, video, flash files, breeze projects, etc. In general, in one embodiment, the files uploaded using the asset management module may only be linked to by a course module and then displayed when the course module is being accessed. The asset management module 506 is responsible for organizing and storing the various assets including not only the course modules, but related documents that are called from the course modules. In one embodiment, the asset management module 506 is also accessed when updating courses, creating new courses, or upon approval of the course entering the course into live status.

In one embodiment, a content transformation module 505 may additionally be included to transform content entered and stored as XML files in the content entry module 504 into Flash-based course training modules. When the content transformation module 505 is accessed in one embodiment, Flash is initiated to read an XML file and convert it to an instance of the XML class. An XML instance is used for schema-driven data editing that allows for the creation, editing, and management of data-oriented XML documents. Flash will enable information in an XML file to be read into an instance of the XML class, which has predefined methods and properties associated with it.

Because XML access is an asynchronous operation, before the content transformation module 505 issues a command to load the XML data, the content transformation module sets up a main function and assigns it to the XML instance's onLoad event property. The onLoad event property is an event handler that is invoked by Flash Player when an XML document is received from the server. The main function contains everything that is to occur once the XML data is available (including parsing the XML into a useable format if necessary or calling other functions). Once the content has been received, the main function may be accessed by the Flash module and the XML data is loaded using the Flash module. The main function is responsible for rendering all data fields, layout formats, and content properties. By having separate XML data and performing these steps, updating content and layout is made much simpler, because now there is no need to edit a Flash source file.

In one embodiment, a Q/A module 508 will place a project into a review queue to be reviewed by a quality assurance team, and in some embodiments, the stakeholder responsible for the project. The Q/A module 508, upon placing the project including source file or files into the asset manager, may send an e-mail or other notification to project reviewers notifying them that there is a project to be reviewed. The Q/A module ensures that every project goes through the quality assurance process before becoming live. In one embodiment, if a project is currently under review it will be indicated with Q/A label allowing users to know that while the project is not live, it is at least being reviewed. In one embodiment, if any edits are made to a project that is currently under review, the Q/A module will ensure that a new review is initiated each time changes are made to the project until the Q/A process is complete or in other words the project has been approved. Projects that are approved using the Q/A module may then be released into the asset management module 506 and become indicated as “live.”

A content update module 510 may be provided to edit content that is already approved or may be used to update content in the development process as well. The table of contents previously created may be displayed upon calling the content update module 510 which will allow the user to rearrange the order of modules within a project, delete modules, or edit individual modules as selected. It is important to note that in some embodiments, deleting modules or projects may only be available at various permission levels in order to maintain the integrity of the system. In addition, when editing existing modules, or rearranging them within a project, the content update module may additionally allow a user to add new modules within the project or may allow the user to change the status of modules within the project, such as making some inactive if the user wishes to do so.

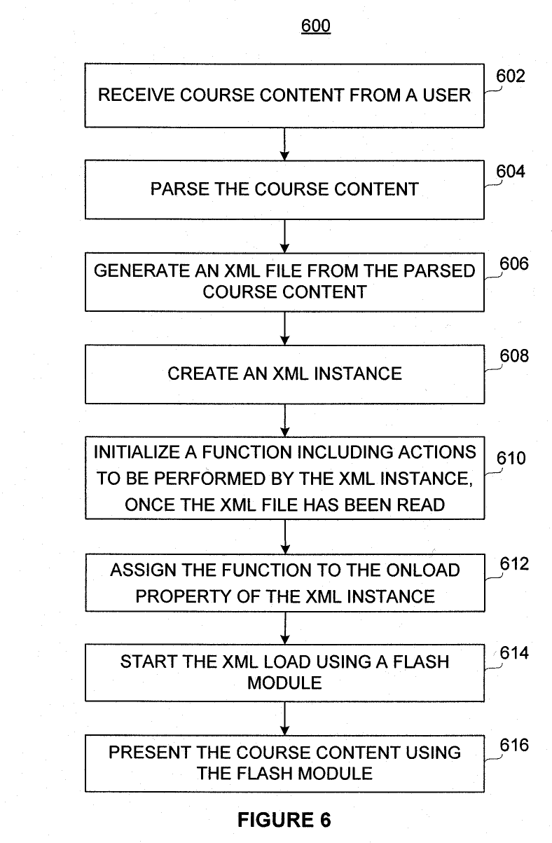

FIG. 6 is a flow chart of one embodiment of a method for generating Flash-based educational training courses. In step 602, course content may be received from a user. Using an author interface, as described in FIG. 1, or another computing device, an author of a training module may create a training course intended for use on the training course server. The course content, if generated on a separate computing device from the training course server, must be communicated to the training course server for processing, or if already processed by the author interface, the course content may be communicated at least for storage and management reasons.

In step 604, the course content may be parsed. By breaking the content into data pieces, the content may be broken into different fields, allowing for the creation of an XML file. For example, in step 606, an XML file may be generated from the parsed course content. XML files resemble HTML code, in that the content is broken into fields, with each field representing a characteristic of the parsed content. XML also allows for a universally understood format to be used by the training course server. If content is labeled with a content type or description, such as in XML, the content can easily be converted to any style in which the end user ultimately wants. This flexibility allows for data to be entered in one time and many different formats of training courses ultimately derived.

In step 608, an XML instance may be created. As described previously, an XML instance is used for schema-driven data editing that allows for the creation, editing, and management of data-oriented XML documents. In step 610 a function including actions to perform by the XML instance may be initialized, once the XML file has been read. This allows time for the XML data to be transferred and read before proceeding. The main function is also responsible for rendering all data fields, layout formats, and content properties. In step 612, the function may be assigned to the onLoad property of the XML instance. The onLoad event property is an event handler that is invoked by Flash Player when an XML document is received from the server. In step 614 the XML load may be started using a Flash module, and in step 616, the course content may be presented using the Flash module.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

1. A method for generating a Flash-based educational training course, said method comprising:
receiving course content from a user;
parsing the course content;
generating an XML file from the parsed course content;
creating an XML instance,
initializing a function including actions to be performed by the XML instance, once the XML file has been read;
assigning the function to the onLoad property of the XML instance;
starting the XML toad using a Flash module; and
presenting the course content using the Flash module.

2. The method according to claim 1, further comprising generating a table of contents indexing course content.

3. The method according to claim 2, wherein changing course content within a training course automatically edits the generated table of contents.

4. The method according to claim 1 further comprising requesting a review of the course content.

5. The method according to claim 4, further comprising inhibiting release of the course content, in response to a failed review.

6. The method according to claim 1, further including storing the generated XML file in a document management process.

7. The method according to claim 6, further comprising reusing stored XML files for future course content.

8. The method according to claim 1, further performing find and replace functions.

9. The method according to claim 1, wherein the initialized function additionally renders all data files, layout formats, and content properties.

10. The method according to claim 1, wherein presenting the course content using the flash modules, further includes combining an interaction template with the generated XML file.

11. A system for generating a Flash-based educational training course, said system comprising:
a processor;
a memory;
data;
said data being stored by the memory and accessible by the processor;
said processor configured to:
receive course content from a user;
parse the course content;
generate an XML file from the parsed course content;
create an XML instance,
initialize a function including actions to perform by the XML instance, once the XML file has been read;
assign the function to the onLoad property of the XML instance;
start the XML load using a Flash module; and
present the course content using the Flash module.

12. The system according to claim 11, wherein the processor is further configured to generate a table of contents indexing course content.

13. The system according to claim 12, wherein in changing course content within a training course, the processor is configured to automatically edit the generated table of contents.

14. The system according to claim 11, wherein the processor is further configured to request a review of the course content.

15. The system according to claim 14, wherein the processor is further configured to inhibit release of the course content, in response to a failed review.

16. The system according to claim 11, wherein the processor is further configured to generate an XML file in a document management process.

17. The system according to claim 16, wherein the processor is further configured to reuse stored XML files for future course content.

18. The system according to claim 11, wherein the processor is further configured to perform find and replace functions.

19. The system according to claim 11, wherein the initialized function additionally renders all data files, layout formats, and content properties.

20. The system according to claim 11, wherein, in presenting the course content using the flash modules, the processor is further configured to combine an interaction template with the generated XML file.
